(19) United States
(12) Patent Application Publication
(10) Pub. No.: US 2016/0286301 A1
(43) Pub. Date: Sep. 29, 2016

(54) LOUDSPEAKER ASSEMBLY WITH SUPPRESSION OF MAGNETIC FLUX MODULATION DISTORTION

(71) Applicant: DANMARKS TEKNISKE UNIVERSITET, Kgs. Lyngby (DK)

(72) Inventors: Finn Agerkvist, Søborg (DK); Niccolo Antonello, Castelfranco Veneto (IT); Anders Christensen, Smørum (DK)

(21) Appl. No.: 15/034,075

(22) PCT Filed: Nov. 4, 2014
(86) PCT No.: PCT/EP2014/073655

§ 371 Date: May 3, 2016

(30) Foreign Application Priority Data
Nov. 6, 2013 (EP) 13191749.4

(51) Int. Cl. H04R 1/22; H04R 29/00; H04R 3/08; H04R 9/06; H04R 9/02

(52) U.S. Cl. CPC H04R 1/22; H04R 9/06; H04R 9/025; H04R 3/08; H04R 29/003; H04R 2201/028

(57) ABSTRACT

An electrodynamic loudspeaker assembly having an electrodynamic loudspeaker and first and second compensation filters. The electrodynamic loudspeaker includes a voice coil arranged in an air gap of a magnetically permeable structure and a compensation coil wound around a portion of the magnetically permeable structure. The first compensation filter filters an audio input signal to the loudspeaker assembly with a first frequency response to generate a voice coil compensation signal for application to the voice coil. The second compensation filter filters the audio input signal to the loudspeaker assembly with a second frequency response to generate a second compensation signal for application to the compensation coil. The first and second frequency responses, across a predetermined audio frequency range, suppress a time-varying or AC magnetic flux in the air gap caused by voice coil current such that magnetic flux modulation in the air gap of the loudspeaker is suppressed.

The present invention relates to an electrodynamic loudspeaker assembly which comprises an electrodynamic loudspeaker and first and second compensation filters. The electrodynamic loudspeaker comprises a voice coil arranged in an air gap of a magnetically permeable structure and a compensation coil wound around a portion of the magnetically permeable structure. The first compensation filter of the assembly is configured to filtering an audio input signal to the loudspeaker assembly with a first frequency response to generate a voice coil compensation signal for application to the voice coil. The second compensation filter of the assembly is configured to filtering the audio input signal to the loudspeaker assembly with a second frequency response to generate a second compensation signal for application to the compensation coil. The first and second frequency responses are configured to, across a predetermined audio frequency range, suppress a time-varying or AC magnetic flux in the air gap caused by voice coil current such that magnetic flux modulation in the air gap of the electrodynamic loudspeaker is suppressed.

### BACKGROUND OF THE INVENTION

The present invention relates to an electrodynamic loudspeaker assembly which comprises a compensation coil that suppresses or eliminates magnetic flux modulation in the air gap of the electrodynamic loudspeaker. One of the factors that may characterize sound quality of an electrodynamic loudspeaker is its ability of creating undistorted sound. It is well-known that sources of the distortion artifacts in the reproduced sound are due to the non-linearities of the loudspeaker device. These non-linearities can be, for example, a displacement dependency of force factor, compliance of the diaphragm or inductance of the voice coil etc. Among these non-linearities, magnetic flux modulation in the air gap represents one of the main sources of distortion. The most common prior art technique to reduce this effect is to mount some highly conductive materials rings in the loudspeaker's iron structure [1]. These conductive rings behave like a transformer coupled with the voice coil and are able to create a magnetic flux which tries to oppose the AC-flux in the air gap where the voice coil is placed and therefore reducing flux modulation.

GB 2 235 350 discloses an electrodynamic loudspeaker with a voice coil arranged in an air gap of a magnetic circuit. The loudspeaker comprises a stationary compensation coil wound around a center pole of the magnetic circuit and situated outside the air gap. The compensation coil seeks to generate a magnetic flux that opposes the magnetic flux generated by the voice coil such the net AC flux produced by both is zero, or substantially zero. The compensation coil is electrically connected in series with the voice coil but in opposite phase.

The present invention comprises an active method either suppressing or preferably completely eliminating this type of magnetic flux distortion by means of an actively controlled additional fixed coil or compensation coil. The use of an additional coil for suppression of magnetic flux modulation in electrodynamic loudspeaker is disclosed in references [2], [3] in addition to the above mentioned GB 2 235 350 patent document. In the former references the compensation coil is placed in the air gap of the loudspeaker which is impractical for numerous reasons in view of the small dimensions of ordinary air gap and the desire to produce a high magnetic flux density in the air gap. The compensation coil disclosed by GB 2 235 350 is on the other hand unable to effectively cancel the magnetic flux modulation across any significant audio frequency range inter alia because of a mismatch between the impedance of the displaceable voice coil, which inherently comprises a motional impedance component, and the impedance of the stationary compensation coil.

It is of significant interest and value to provide a more generic loudspeaker assembly and flux modulation suppression methodology that allows a flexible choice of placement of the compensation coil and an accurate way of suppressing magnetic flux modulation across a predetermined audio frequency range.

### SUMMARY OF THE INVENTION

A first aspect of the invention relates to an electrodynamic loudspeaker assembly comprising an electrodynamic loudspeaker. The electrodynamic loudspeaker comprising:

a magnetic circuit comprising a magnetically permeable structure having an air gap arranged therein and a magnetic flux generator configured to produce a constant or DC magnetic flux through the magnetically permeable structure and air gap,

a movable diaphragm assembly comprising a voice coil arranged in the air gap,

a compensation coil wound around a portion of the magnetically permeable structure to produce a compensation magnetic flux in the air gap in accordance with a compensation signal; and the electrodynamic loudspeaker assembly further comprising:

a first compensation filter configured to filtering an audio input signal to the loudspeaker assembly with a first frequency response to generate a voice coil compensation signal for application to the voice coil,

a second compensation filter configured to filtering the audio input signal to the loudspeaker assembly with a second frequency response to generate a second compensation signal for application to the compensation coil,

wherein the first and second frequency responses are configured to, across a predetermined audio frequency range, suppress a time-varying or AC magnetic flux in the air gap caused by voice coil current such that magnetic flux modulation in the air gap of the electrodynamic loudspeaker is suppressed.

The skilled person will understand that the present electrodynamic loudspeaker assembly may comprise a broad range of electrodynamic loudspeakers with different impedances, dimensions and power ratings from large woofers for Hi-Fi or Public Address applications to miniature broadband loudspeakers for portable computing or communication devices such as mobile phones and laptop computers.

The application of the first and second compensation filters to tailor the frequency responses of the respective compensation signals of the voice coil and compensation coil is capable of providing accurate flux modulation suppression across a wide audio frequency range such as a range between 20 Hz and 20 kHz or a range from 100 Hz to 10 kHz. By proper selection of the first and second frequency responses, e.g. based on certain calibration measurements as described in detail below with reference to the appended drawings, it is possible to effectively suppress the AC magnetic flux in the air gap caused by the voice coil current for a wide range of positions and electric characteristics of each of the compensation coil and voice coil.

The movable diaphragm assembly comprises a diaphragm which may be attached to a frame of the electrodynamic loudspeaker via a resilient edge suspension in certain embodiments of the invention. In alternative embodiments, the diaphragm may be attached directly to the frame of the electrodynamic loudspeaker such that the diaphragm material forms the suspension. The respective number of windings and DC resistances of the voice coil and compensation coil will vary depending on the particular type of loudspeaker. In a number of useful embodiments a DC resistance of the voice coil lies between 1Ω and 100Ω such as between 2ω and 32Ω and a DC resistance of the compensation coil lies between 0.5Ω and 50Ω for example between 1Ω and 25Ω. The DC resistance of the voice coil may be identical to the DC resistance of the compensation coil is some embodiments and differ in other embodiments as suggested by the above resistance ranges. The number of windings of the voice coil and compensation coil may be identical or differ for example depending on the characteristics of the first and second frequency responses of the first and second compensation filters, respectively.

The compensation coil may in principle by arranged at any location of the magnetically permeable structure, but various mechanical constraints dictated by the dimensions of the compensation coil may of course make certain positions more practical than others. In one embodiment, the compensation coil is wound around a center pole of the magnetically permeable structure because the latter is often readily accessible for placement of the compensation coil in ordinary loudspeaker designs.

The audio input signal applied to the electrodynamic loudspeaker assembly for sound reproduction during normal operation may comprise speech and/or music supplied from a suitable audio source such as radio, CD player, network player, MP3 player etc. The audio source may also comprise a microphone generating a real-time microphone signal in response to incoming sound.

The skilled person will appreciate that each of the first and second compensation filters may comprise an analog filter or a digital filter or a combination of both. If each of the first and second compensation filters comprises a digital filter, the audio input signal may be provided in digital format from the audio signal source. The digital audio input signal may be in a format that is directly applicable to the first and second compensation filters or need format conversion. The digital audio input signal audio signal may for example be formatted according to a standardized serial data communication protocol such as IIC or SPI, or formatted according to a digital audio protocol such as I²S, SPDIF etc. In the alternative, the audio input signal may be provided in analog format and sampled and converted into a suitable digital format by an analog-digital converter of the assembly before application to the first and second digital compensation filters. The skilled person will understand that the first and second digital compensation filters may be implemented as a filter routine or program on a software programmable microprocessor or DSP integrated on, or operatively coupled to, the loudspeaker assembly. The filter routine or program may comprise a set of executable program instructions stored in a program memory of the microprocessor or DSP.

According to a preferred embodiment, each of the first and second frequency responses of the first and second compensation filters, respectively, is substantially time invariant. This embodiment simplifies the design and minimizes complexity of the compensation filters. Alternatively, each of the first and second frequency responses of the first and second compensation filters, respectively, may be adaptive or time-varying for example varying in time in accordance with instantaneous displacement of the diaphragm assembly from its rest position or unbiased position.

According to a preferred embodiment of the electrodynamic loudspeaker assembly the first frequency response T_{VC} of the first compensation filter and the second frequency response T_{FC} of the second compensation filter are selected such that the respective frequency responses are conforming to:

$$\begin{matrix}{T}_{VC} = 1 + \frac{{H}_{21} {H}_{μ , 1}}{{H}_{μ , 2} {H}_{11} - {H}_{μ , 1} {H}_{21}} & ( 11 a ) \\ {T}_{FC} = - \frac{{H}_{11} {H}_{μ , 1}}{{H}_{μ , 2} {H}_{11} - {H}_{μ , 1} {H}_{21}} . & ( 11 b )\end{matrix}$$

wherein:

H₁₁: A voice coil admittance transfer function across the predetermined audio frequency range;

H₂₁: A transfer function between the second compensation signal, of the compensation coil, and the current in the voice coil across the predetermined audio frequency range;

H_{μ,1}: A transfer function between the voice coil compensation signal of the voice coil and a magnetizing inductance representing the mutual inductance created by a magnetic flux in common with the voice coil and compensation coil across the predetermined audio frequency range;

H_{μ,2}: A transfer function between the second compensation signal, of the compensation coil, and the magnetizing inductance across the predetermined audio frequency range.

The outputs of the first and second compensation filters may be directly coupled to the voice coil and compensation if output impedance of each of these filters is appropriately matched to the respective impedances of the voice coil and compensation coil. Alternatively, a first power amplifier or buffer may inserted between the voice coil compensation signal and the voice coil and a second power amplifier or buffer inserted between the output of the second compensation filter and the compensation coil. Each of the first and second power amplifiers or buffers may comprise a switching or class D amplifier for example a Pulse Density Modulation (PDM) or Pulse Width Modulation (PWM) output amplifier which possess high power conversion efficiency. This is a particularly advantageous feature for use in battery powered portable communication devices. In the alternative, each of the first and second power amplifiers may comprise a traditional non-switched power amplifier topology like class A or class AB. The latter embodiments with power amplifiers or buffers will often allow a flexible selection of the respective impedances of the voice coil and compensation coil because the output impedances of typical power amplifiers or buffers are low compared to practical coil impedances. The output impedance of each of the power amplifiers or buffers may for example be smaller than 0.1Ω.

The voice coil may have a DC resistance between 1Ω and 100Ω and the compensation coil may have a DC resistance between 0.5Ω and 50Ω. The impedance range of the voice coil will cover a wide range of practical loudspeaker designs.

If each of the first and second compensation filters comprises a digital filter as discussed above, the electrodynamic loudspeaker assembly may comprise a first analog-to-digital converter configured to convert the audio input signal into a digital audio input signal at a predetermined sample rate. The sample rate or sampling frequency may be a standardized digital audio frequency such as 16 kHz, 32 kHz, 44.1 kHz, 48 kHz, 96 kHz etc. In the alternative, the audio input signal may be provided in digital format at the predetermined sample rate such that the first analog-to-digital converter becomes superfluous.

The magnetic flux generator may comprise at least one permanent magnet configured to produce the constant or DC magnetic flux through the magnetically permeable structure.

A second aspect of the invention relates to a sound reproducing system comprising an electrodynamic loudspeaker assembly according to any of the preceding claims. The sound reproducing system may comprise an active loudspeaker with build-in power supply and one or more power amplifiers coupled to respective electrodynamic loudspeakers.

A third aspect of the invention relates to a method of suppressing magnetic flux modulation in an air gap of an electrodynamic loudspeaker, comprising steps of:

producing a magnetic flux in the air gap of the electrodynamic loudspeaker, coupling a first compensation filter having a first frequency response to a voice coil of the electrodynamic loudspeaker,

coupling a second compensation filter having a second frequency response to a compensation coil wound around a portion of a magnetically permeable structure of the electrodynamic loudspeaker,

applying an audio input signal from an audio signal source to each of the voice coil compensation filter and second compensation filter to supply a voice coil compensation signal to the voice coil and a second compensation signal to the compensation coil,

adjusting the first and second frequency responses to, across a predetermined audio frequency range, suppress a time-varying or AC magnetic flux in the air gap caused by voice coil current thereby suppressing magnetic flux modulation in the air gap.

The adjustment of the first and second frequency responses is preferably performed by or during a calibration procedure that comprises steps of:

determining a voice coil admittance function H₁₁ across the predetermined audio frequency range;

determining a transfer function H₂₁ between the second compensation signal, of the compensation coil, and the current in the voice coil across the predetermined audio frequency range;

determining a transfer function H_{μ,1} between the voice coil compensation signal and a magnetizing inductance representing the mutual inductance created by a magnetic flux in common with the voice coil and compensation coil across the predetermined audio frequency range;

determining a transfer function H_{μ,2} between the second compensation signal, of the compensation coil, and the magnetizing inductance across the predetermined audio frequency range; and

adjusting the first frequency response T_{VC} of the first compensation filter and adjusting the second frequency response T_{FC} of the second compensation filter in accordance with:

$$\begin{matrix}{T}_{VC} = 1 + \frac{{H}_{21} {H}_{μ , 1}}{{H}_{μ , 2} {H}_{11} - {H}_{μ , 1} {H}_{21}} & ( 11 a ) \\ {T}_{FC} = - \frac{{H}_{11} {H}_{μ , 1}}{{H}_{μ , 2} {H}_{11} - {H}_{μ , 1} {H}_{21}} . & ( 11 b )\end{matrix}$$

The determination of the transfer functions H_{μ,1} and H_{μ,2} during the calibration procedure may be carried out in several different ways. According one embodiment, the transfer functions H_{μ,1} and H_{μ,2} are determined by steps of:

determining the transfer function H_{μ,1} by inserting a field pick-up coil or inductor with known inductance into the air gap and measuring a first response signal of the field pick-up coil to the voice coil compensation signal,

determining the transfer function H_{μ,2} by inserting the field pick-up coil or inductor into the air gap and measuring a second response signal of the field pick-up coil to the second compensation signal.

An alternative embodiment of the calibration procedure determines the transfer functions H_{μ,1} and H_{μ,2} by steps of:

coupling a force transducer to the voice coil to measure a plurality of force values on voice coil in response to respective combinations of voice coil current and compensation coil current,

varying the voice coil and compensation coil currents independently in order to determining the transfer functions H_{μ,1} and H_{μ,2} by separating the force contributions of the voice coil current and the compensation coil current to the measured force values on the voice coil according to:

$${F}_{L} = Bl \cdot i = {bL}_{μ} {i}_{μ} i = {bL}_{μ} ( {i}^{2} + \frac{1}{K} {i}_{2} i ) ,$$

The method of suppressing magnetic flux modulation may comprise adaptively adjusting each of the first and second frequency responses of the first and second compensation filters, respectively, over time in accordance with instantaneous displacement of the diaphragm assembly from its centered or unbiased position.

### BRIEF DESCRIPTION OF THE DRAWINGS

Preferred embodiments of the invention will be described in more detail in connection with the appended drawings, in which:

FIG. 1 is a schematic electrical equivalent diagram of an electrodynamic loudspeaker with a compensation coil suitable for use as a component of a loudspeaker assembly in accordance with a first embodiment of the invention,

FIG. 2A) shows a schematic block diagram of a loudspeaker assembly in accordance with the first embodiment of the invention,

FIG. 2B) shows a schematic block diagram of a loudspeaker assembly in accordance with a second embodiment of the invention,

FIG. 3 is a schematic diagram of a simple magnetic circuit used for experimental verification of the suppression of magnetic flux modulation,

FIG. 4 shows four graphs of measured transfer functions of an electrodynamic loudspeaker with a compensation coil,

FIG. 5 shows four further graphs of measured transfer functions of the electrodynamic loudspeaker with the compensation coil; and

FIG. 6 shows determined frequency responses of a first compensation filter for the voice coil and determined frequency responses of a second compensation filter for the compensation coil.

### DETAILED DESCRIPTION OF PREFERRED EMBODIMENTS

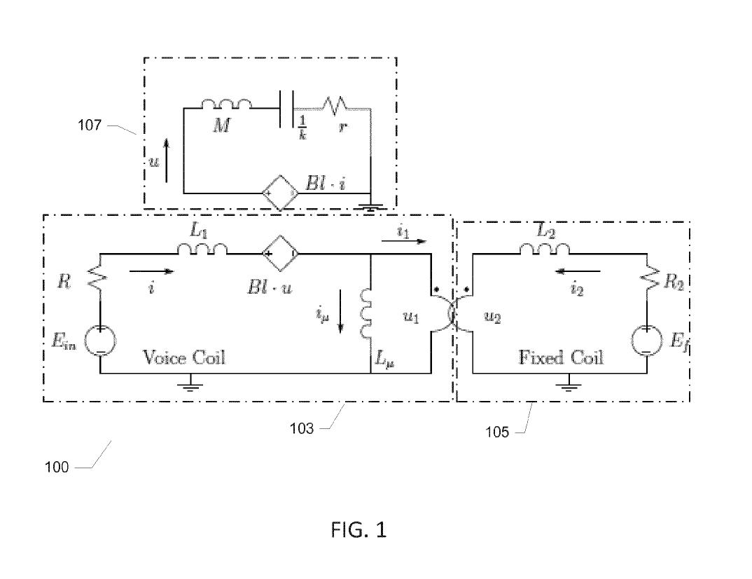

FIG. 1 is a schematic electrical equivalent diagram 100 of an electrodynamic loudspeaker comprising a fixed or compensation coil suitable as a component of the below discussed loudspeaker assembly in accordance with a first embodiment of the invention. Notice that in the following description for simplicity the permanent magnet of the loudspeaker will be replaced by supplying the compensation or fixed coil with a DC current which represent the magnetomotive force of a permanent magnet in a magnetic circuit of the loudspeaker. As illustrated on the drawing, the voice coil impedance of the voice coil equivalent circuit 103 is modeled by a resistor R, an inductance L₁, a back-emf due to the mechanical system BI*u—so far an ordinary model of a normal loudspeaker—in series with a transformer that connects the voice coil to the compensation coil. The compensation coil of the compensation coil equivalent circuit 105 has a similar impedance with a resistor R₂ and an inductance L₂. The equivalent circuit for the mechanical system 107 is depicted above the voice coil and compensation coil equivalent circuits 103, 105. The transformer is modeled by an ideal transformer indicated by u₁ and u₂ placed in parallel with an inductance L_{μ}. The ideal transformer, u₁ and u₂, couples the voltages and currents at its input and output with the following relations:

$$\begin{matrix}\frac{{u}_{1}}{{u}_{2}} = K & ( 1 a ) \\ \frac{{i}_{1}}{{i}_{2}} = - \frac{1}{K} , & ( 1 b )\end{matrix}$$

where K is the gain of the transformer, which, ideally, is given by the ratio of the number of windings of the primary and secondary coils: K=N1=N2. L_{μ} is called a magnetizing inductance that represents a mutual inductance created by the magnetic flux in common with the voice coil and the compensation coil, i.e. both coils. On the other hand, L₁ and L₂ are leakage inductances for the voice coil and compensation coil, respectively. These represent the magnetic flux leakages of both coils, i.e. the magnetic flux that is not mutual. The magnetic flux is therefore the mutual flux, assuming no fringing field is present. Since the flux leakages of the voice coil and compensation coil are already considered in the electrical circuit by L₁ and L₂, Hopkinson's law may be written for the magnetic circuit as:

N₁i+N₂i₂= [symbol] φ, (2)

where R is the reluctance of the magnetic circuit. It should include the effect of both the reluctances of the magnetic core and of the air gap and the reluctance of any permanent magnets in a magnetic circuit of the loudspeaker. Looking at the voice coil circuit 103 of FIG. 1 Kirchhoff's current law states: i=i₁+i_{μ}:

Using the latter equation with (2) and (1b) will give:

$$φ = \frac{{N}_{1} {i}_{μ}}{ℋ} .$$

The flux density can be obtained simply by dividing a cross sectional area, Ag, of the air gap in which the voice coil is arranged under the assumption that the effect of magnetic fringing fields is negligible. Hence, the force factor of the loudspeaker can be expressed in terms of i_{μ} and L_{μ}, knowing that L_{μ}=N1²/R:

$$Bl = \frac{{L}_{μ} {i}_{μ}}{{N}_{1} {A}_{g}} l = {i}_{μ} {L}_{μ} {b}_{i}$$

where b is dependent only of geometrical values sometimes difficult to obtain (consider the effective length I of the expression of the force factor). Since i_{μ} is dependent on the current in the voice coil using this expression for the force factor will introduce a non-linearity in the system. This non-linearity represents the magnetic flux modulation, i.e. representing the mechanism that the B-field throughout the air gap is not constant, but has an AC field component caused by the voice coil current.

Looking now at the expression of the Lorentz force exerted on the voice coil:

$${F}_{L} = Bl \cdot i = {bL}_{μ} {i}_{μ} i = {bL}_{μ} ( {i}^{2} + \frac{1}{K} {i}_{2} i ) ,$$

In this equation, the first term of the right hand side represents the non-linear distortion due to the magnetic flux modulation while the second term is the sought constant force. Clearly, if i_{μ} was constant this non-linear distortion effect would be eliminated.

This circuit does not take into account the effect of eddy currents and an improved model of the circuit can be found in references [1] and [3] to further refine the loudspeaker equivalent circuit.

Now that the circuit of a speaker with an additional coil was implemented and the flux modulation distortion was described, the technique for the magnetic flux modulation compensation can be introduced. The “hat” notation in the following indicates complex notation. This assumes that the modeled electrodynamic loudspeaker is essentially linear which is an assumption that can be achieved at least for small levels of the audio input signal. This condition is also satisfied by the magnetic circuit when it is not saturating. Hence the loudspeaker can be viewed as a system:

î=ÊᵢₙH₁₁+Ê_{f}H₂₁ (7a)

î₂=ÊᵢₙH₁₂+Ê_{f}H₂₂ (7b)

î_{μ}=ÊᵢₙH_{μ,1}+Ê_{f}H_{μ,2}, (7c)

where the transfer functions H represent the ratio between the currents and the input voltages [symbol] and [symbol] . For example H₁₁ can be obtained with the ratio

$${H}_{11} = \frac{\hat{ι}}{{\hat{E}}_{i n}}$$

when [symbol] is set to zero. The latter is simply an inverse of the voice coil impedance H₁₁=Z_{VC}⁻¹ and H₂₂ would be the inverse of the compensation coil impedance. The transfer functions H₂₁ and H₁₂ are due to the transformer action, i.e. the generator in one of the voice coil and compensation coil will induce a current in the other coil.

Assuming that ê is the electrical audio signal to be reproduced by the device, in equation (7b) [symbol] is chosen to be equal to:

$${\hat{E}}_{i n} = \hat{e} - {\hat{E}}_{f} \frac{{H}_{21}}{{H}_{11}} \qquad ( 8 )$$

the current in the primary will be equal î₁=ê multiplied by H₁₁. Therefore the effect of the secondary current will be cancelled. Now the magnetizing current may be forced to be zero, î_{μ}=0, meaning that no AC magnetic flux components are wanted in the magnetic circuit and air gap to avoid flux modulation.

Combining equation (8) with (7c) makes it possible to compute the required compensation in the compensation coil:

$${\hat{E}}_{f} = {E}_{f , D C} - \frac{{H}_{11} {H}_{μ , 1}}{{H}_{μ , 2} {H}_{11} - {H}_{μ , 1} {H}_{21}} \hat{e} , \qquad ( 9 )$$

Notice that in the latter expression the DC component E_{f, DC} was reintroduced, which could be simply representing the DC magnetic flux generated by the permanent magnet of the loudspeaker. Finally equation (8) can be written again as:

$${\hat{E}}_{i n} = \hat{e} + \frac{{H}_{21} {H}_{μ , 1}}{{H}_{μ , 2} {H}_{11} - {H}_{μ , 1} {H}_{21}} \hat{e} . \qquad ( 10 )$$

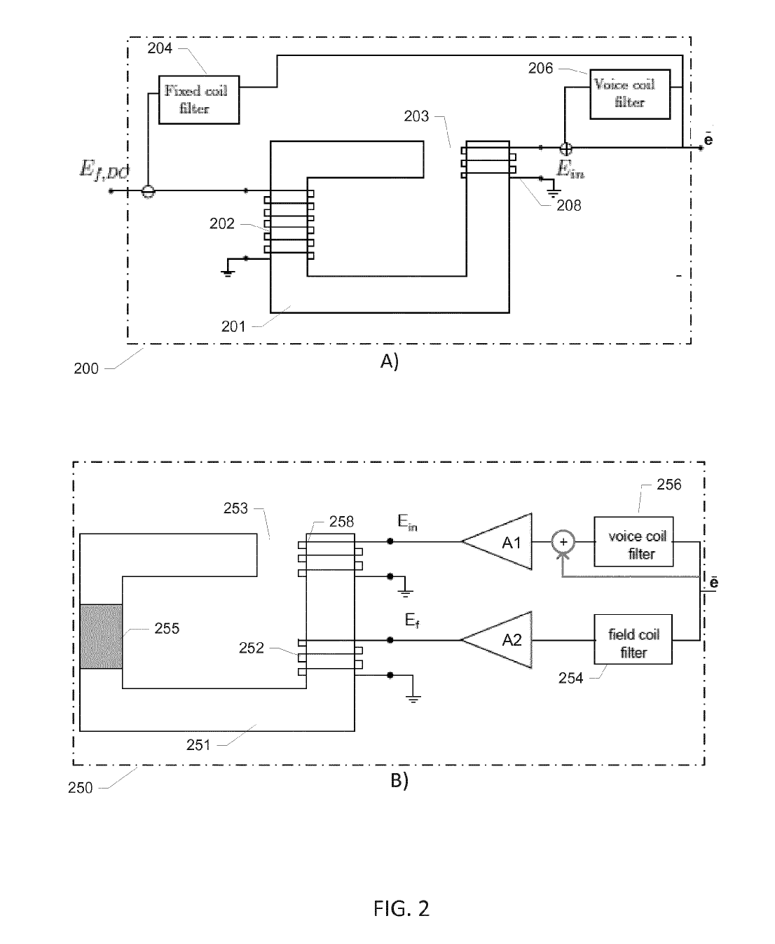

Equations (10) and (9) represent the total compensation system used to avoid interference between the coils and to cancel AC flux in the air gap. Hence, equations (10) and (9) represent the total compensation system or mechanism applied to avoid interference between the compensation and voice coils and to cancel the AC magnetic flux in the air gap. Hence this mechanism comprises arranging a first compensation filter 206 in series with the voice coil 208 and arranging a second compensation filter 204 in series with the compensation coil 202 as schematically illustrated on the electrodynamic loudspeaker assembly depicted on FIG. 2A) in accordance with a first embodiment of the invention. The respective transfer functions of the voice coil compensation filter and the second compensation filter 206, 204 can be expressed as:

$$\begin{matrix}{T}_{VC} = 1 + \frac{{H}_{21} {H}_{μ , 1}}{{H}_{μ , 2} {H}_{11} - {H}_{μ , 1} {H}_{21}} & ( 11 a ) \\ {T}_{FC} = - \frac{{H}_{11} {H}_{μ , 1}}{{H}_{μ , 2} {H}_{11} - {H}_{μ , 1} {H}_{21}} . & ( 11 b )\end{matrix}$$

wherein T_{VC} is the transfer function of the first compensation filter 206 and T_{FC} is the transfer function of the second compensation filter 204.

The simplified electrodynamic loudspeaker assembly 200 depicted on FIG. 2A) comprises a magnetic circuit comprising a magnetically permeable structure 201 having the air gap 203 arranged therein. A magnetic flux generator is schematically depicted by the DC voltage source E_{f, DC} which produces a DC current in the compensation coil 202 wound around a leg of the magnetically permeable structure 201 and thereby induces a constant DC magnetic flux through the magnetically permeable structure 201 and in the air gap 203. The electrodynamic loudspeaker also comprises a movable diaphragm assembly (not shown) comprising the voice coil 208 which is arranged in the air gap 203. The movable diaphragm assembly may be mechanically connected to a frame (not shown) of the electrodynamic loudspeaker via a suitable edge suspension in an ordinary manner. The electrodynamic loudspeaker assembly comprises the above-discussed first compensation filter 206 configured to filtering the audio input signal ê applied to the loudspeaker assembly with the frequency response of the first compensation filter 206, T_{VC}. In this manner, a voice coil compensation signal Eᵢₙ is derived from the audio input signal and applied to the voice coil 208. The electrodynamic loudspeaker assembly 200 additionally comprises the above-discussed second compensation filter 204 configured to filtering the audio input signal e with the frequency response of the second compensation filter 204, T_{FC}. In this manner, a second compensation signal is derived from the audio input signal and applied to the compensation coil 202. As explained in detail above, the first and second frequency responses of the first and second compensation filters 206, 204, respectively, are designed or configured such that the time-varying or AC magnetic flux in the air gap 203 caused by voice coil current is suppressed or preferably substantially eliminated across a certain audio frequency range. Thereby, the magnetic flux modulation in the air gap is suppressed. The audio frequency range may vary depending on application specific requirements to the loudspeaker assembly in question. The audio frequency range may extend from 20 Hz to 20 kHz in some applications and to a smaller range in other applications such as from 100 Hz to 10 kHz or 100 Hz to 1 kHz etc.

FIG. 2B) illustrates another embodiment of the present electrodynamic loudspeaker assembly 250. The simplified schematic of the electrodynamic loudspeaker assembly 250 comprises a magnetic circuit comprising a magnetically permeable structure 251 having an air gap 253 arranged therein. A permanent magnet 255 of the magnetic circuit 251 produces a constant DC magnetic flux through the magnetically permeable structure 251 and in the air gap 253. The electrodynamic loudspeaker also comprises a movable diaphragm assembly (not shown) comprising the voice coil 258 which is arranged in the air gap 253. The movable diaphragm assembly may be mechanically connected to a frame (not shown) of the electrodynamic loudspeaker via a suitable edge suspension in an ordinary manner. In addition to the above discussed of the first and second compensation filters 256, 254, respectively, the present embodiment comprises a first power amplifier or buffer A1 and a second a first power amplifier or buffer A2. The first power amplifier or buffer A1 is inserted between the first (or voice coil) compensation signal Eᵢₙ and the voice coil 258. The second power amplifier or buffer A2 is inserted between the second compensation signal E_{f} and the compensation coil 252. The addition of the first and second power amplifier enables these to supply adequate drive current to the respective coils such that a signal source or generator supplying the audio input signal ê is not loaded with the often relatively low impedance of each of these coils. The DC impedance of the voice coil 258 may lie between 1 and 100Ω for a typical loudspeaker design and the DC impedance of the compensation coil 252 may lie between 0.5 and 100Ω. The DC impedance of the voice coil 258 may be substantially identical to the DC impedance of the compensation coil 252 or larger for example more than 2 times larger.

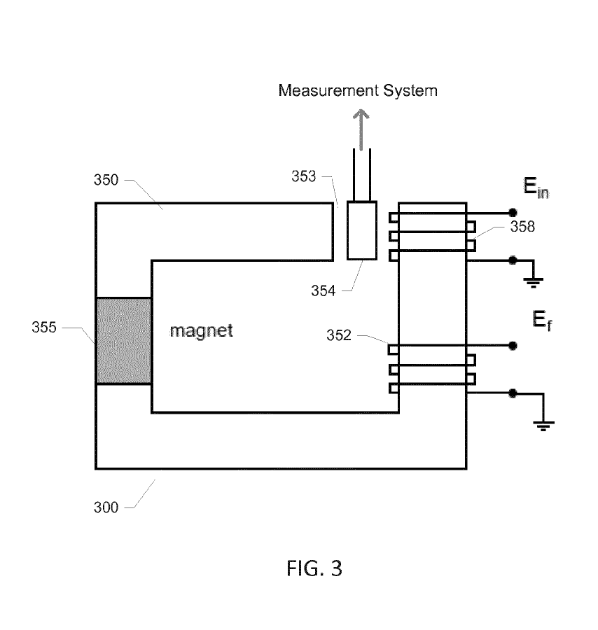

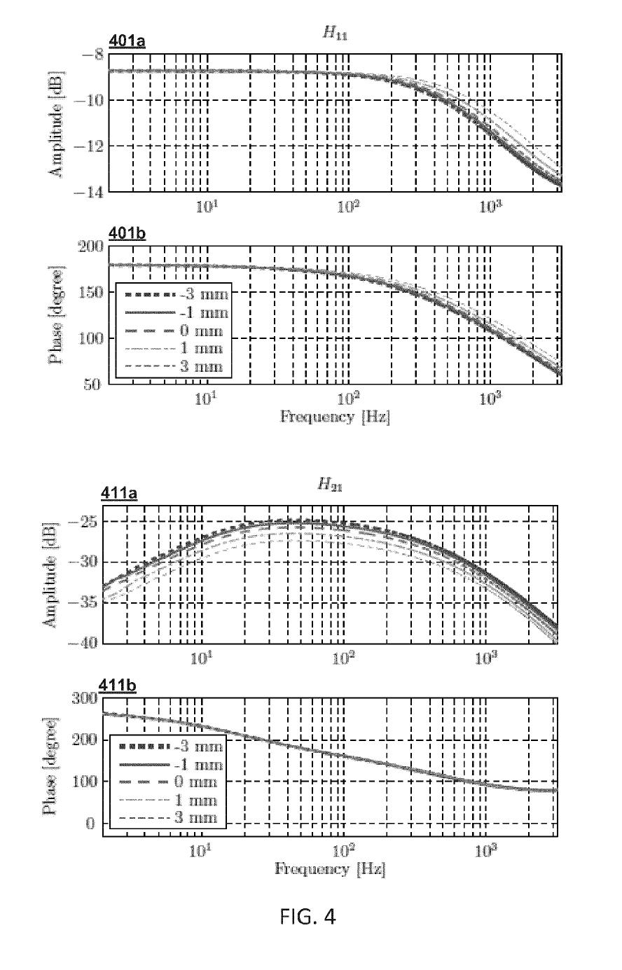

The above-described electrodynamic loudspeaker assemblies and methodologies for suppressing magnetic flux modulation in the magnetic circuit have been experimentally verified by the inventors using an experimental magnetic circuit 300 as illustrated on FIG. 3 which shows the magnetic circuit used to test the flux modulation suppression or compensation technique. The magnetic circuit comprises a magnetically permeable core 350 that may comprise a ferromagnetic material such as untreated iron bars, 8 mm thick and 2 cm wide. An aluminium frame (not shown) is used to avoid any movement of the iron bars. The magnetic circuit further comprises a permanent magnet 355 for generating a DC magnetic flux. There are two fixed coils arranged on the magnetically permeable core 350 formed by a compensation coil 352 made out of 500 winding turns and a fixed voice coil 358 with 300 winding turns. A field pick-up coil 354 is placed inside the air gap 353. Since i_{μ} cannot be measured directly, but is known to be directly proportional to the B*I product, the magnetic flux is measured instead by the pick-up coil 354 via a test voltage induced therein. The test voltage is applied to a measurement system for recordation and processing. The pick-up coil 354 was calibrated with a Helmholtz's coil that produces a known B-field. The above-discussed transfer functions H₁₁, H₂₁, H_{μ,1} and H_{μ,2} were all measured using a suitably configured computerized measurement system such as a Brüel & Kjaer PULSE measurement system. The collection of voice coil admittance transfer functions H₁₁ are shown on graphs 401a,b of FIG. 4 across a frequency range from about 3 Hz to 3 kHz. As stated earlier, this is just the inverse of the voice coil impedance demonstrating the well-known behavior where for low frequencies the transfer function is dominated by the DC resistance of the voice coil and by voice coil inductance for high frequencies.

The collection of transfer functions H₂₁ between the second compensation signal, of the compensation coil, and the current in the voice coils shown on graphs 411a,b of FIG. 4. These graphs illustrate the transformer action that behaves as a band pass filter. The main effect of changing the inductance is again a shift of the amplitude. Another effect, but less prominent, is an increase of the higher cut-off frequency.

Both of the above-mentioned measured transfer functions are the respective curves obtained for zero voice coil displacement “0 mm”, i.e. with the voice coil centred in the air gap.

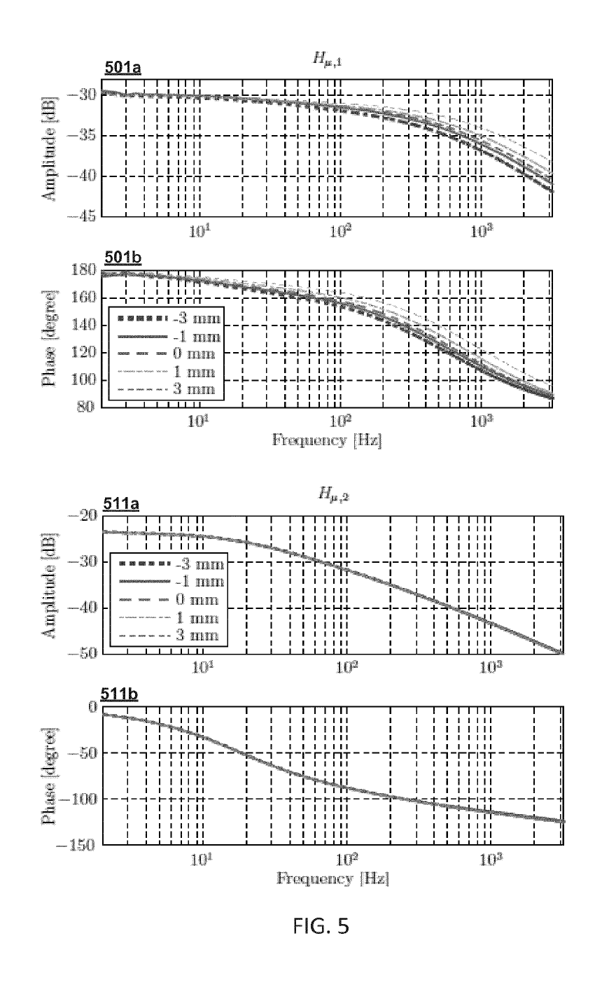

The measured collection of transfer functions, H_{μ,1}, between the voice coil compensation signal of the voice coil and the magnetizing inductance representing the mutual inductance created by a magnetic flux in common with the voice coil and compensation coil are shown on graphs 501a,b of FIG. 5 across a frequency range from about 3 Hz to 3 kHz. The measured transfer functions, H_{μ,2}, between the second compensation signal, applied to the compensation coil, and the magnetizing inductance are shown on graphs 511a,b of FIG. 5 across the frequency range from about 3 Hz to 3 kHz. Both transfer functions are the respective curves obtained for zero voice coil displacement indicated by the “0 mm” legend.

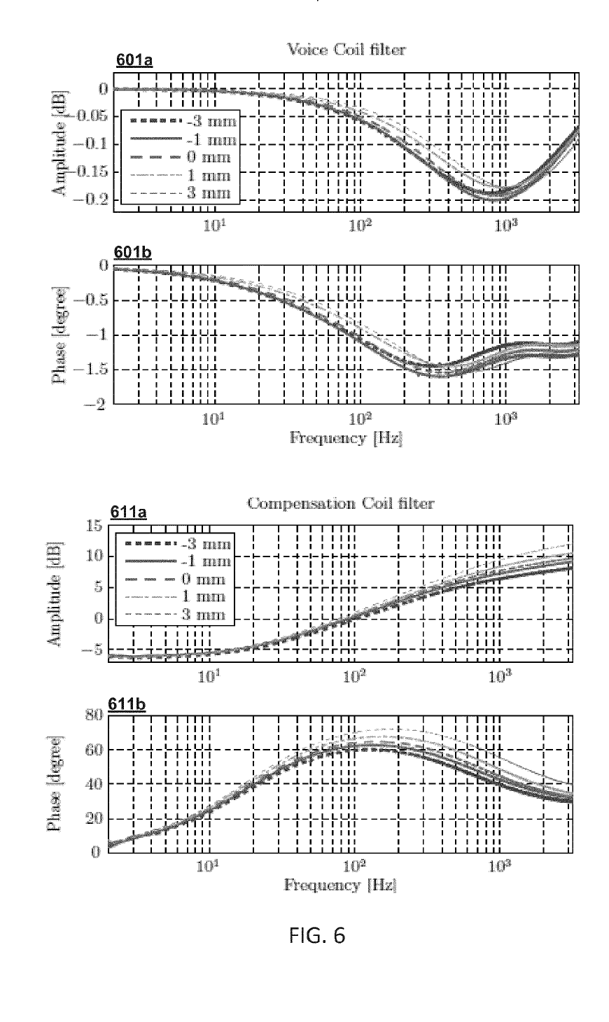

Finally, graphs 601a,b of FIG. 6 show the determined or computed frequency response T_{VC} of the first compensation filter for the voice coil across the frequency range from about 3 Hz to 3 kHz. Graphs 611a,b of FIG. 6 show the determined or computed frequency response T_{FC} of the second compensation filter for the compensation coil across the frequency range from about 3 Hz to 3 kHz. It is evident that at higher frequencies the amplitude of the second compensation signal applied to the compensation coil increases in amplitude above the 0 dB line of graph 611a to reach more than 10 dB. This could represent a potential challenge especially when playing at high sound pressure levels on the loudspeaker because the level of the second compensation signal applied to the compensation coil should be about 10 dB higher than the compensation signal applied to the voice coil, in order to fully exploit the desired flux suppression. However, this challenge could be overcome by a smarter design of the compensation coil, since the compensation coil used in the present experimental measurements has 500 windings and a resistance of 5.5Ω. The number of windings of the compensation coil could be reduced thereby reducing the compensation coil impedance at high frequencies and hence requiring a lower level of the compensation signal for the flux compensation. Moreover, a thicker wire could be used to form the compensation coil and the best trade-off between these two factors should be sought.

The dependency of the voice coil position or displacement in the air gap on the transfer functions H₁₁, H₂₁, H_{μ,1}, and H_{μ,2} was also measured and the resulting effect on the respective frequency responses of the first and second compensation filters T_{VC} and T_{FC} investigated. The pick-up coil was moved in the air gap together with the voice coil to obtain these measurements. Hence, all of these transfer functions were repeatedly measured with voice coil positioned at 0 mm displacement as explained above and then at voice coil displacements of −3 mm, −1 mm, +1 mm and +3 mm as indicated by the respective collection of curves on each of graphs 401a,b, 411a,b, 501a,b, 511a,b, 601a,b and 611a,b. By inspection of the computed frequency response of the first and second compensation filters T_{VC} and T_{FC} on graphs 601a,b and 611a,b it is clear that these transfer functions changes as a function of voice coil displacement. Consequently, a further optimized suppression of the magnetic flux modulation in the air gap could utilize adaptive frequency responses of the of the first and second compensation filters such that these frequency responses varied in accordance with the instantaneous displacement of the voice coil and diaphragm assembly from its rest position.

The suppression of the magnetic flux modulation in the air gap was finally verified by feeding the each of the compensation and voice coils with a sinusoidal input with a phase and amplitude given by the first and second compensation filters that can be calculated from the transfer functions using the above equations 11a and 11b. Several measurement of the suppression of flux modulation were carried out with and without the compensations filters to filter the audio input signal before application to the coils at three different test frequencies: 20 Hz, 220 Hz and 2 kHz. A very significant reduction of the measured magnetic flux modulation of between 23 dB and 53.5 dB was obtained at these test frequencies.

### REFERENCES

[1] Knud Thorborg, Andrew D. Unruh, Electrical Equivalent Circuit Model for Dynamic Moving-Coil Transducers Incorporating a Semiconductor, J. Audio Eng. Soc, vol. 56, pp. 696-709 (2008).

[2] Marco Carlisi, Mario Di Cola, Andrea Manzini, An Alternative Approach to Minimize Inductance and Related Distortions in Loudspeakers, presented at the 118th Convention of the Audio Engineering Society, Barcelona Spain, (2005).

[3] Daniele Ponteggia, Marco Carlisi, Andrea Manzini, Electrical Circuit Model For a Loudspeaker with an Additional Fixed Coil in the Gap, presented at the 128th Convention of the Audio Engineering Society, London UK, (2010).

1. An electrodynamic loudspeaker assembly comprising:
an electrodynamic loudspeaker comprising:
a magnetic circuit comprising a magnetically permeable structure having an air gap arranged therein and a magnetic flux generator configured to produce a constant or DC magnetic flux through the magnetically permeable structure and air gap,
a movable diaphragm assembly comprising a voice coil arranged in the air gap,
a compensation coil wound around a portion of the magnetically permeable structure to produce a compensation magnetic flux in the air gap in accordance with a compensation signal; and
a first compensation filter configured to filtering an audio input signal to the loudspeaker assembly with a first frequency response to generate a voice coil compensation signal for application to the voice coil,
a second compensation filter configured to filtering the audio input signal to the loudspeaker assembly with a second frequency response to generate a second compensation signal for application to the compensation coil,
wherein the first and second frequency responses are configured to, across a predetermined audio frequency range, suppress a time-varying or AC magnetic flux in the air gap caused by voice coil current such that magnetic flux modulation in the air gap of the electrodynamic loudspeaker is suppressed.

2. An electrodynamic loudspeaker assembly according to claim 1, wherein each of the first and second frequency responses of the voice coil compensation filter and the second compensation filter, respectively, is substantially time invariant.

3. An electrodynamic loudspeaker assembly according to claim 1, wherein each of the first and second frequency responses of the first and second compensation filters, respectively, are adaptive or time-varying in accordance with instantaneous displacement of the diaphragm assembly from its rest position.

4. An electrodynamic loudspeaker assembly according to claim 1, wherein the first frequency response T_{VC} of the first compensation filter and the second frequency response T_{FC} of the second compensation filter have frequency responses conforming to:
$${T}_{VC} = 1 + \frac{{H}_{21} {H}_{μ , 1}}{{H}_{μ , 2} {H}_{11} - {H}_{μ , 1} {H}_{21}} , \\ {T}_{FC} = - \frac{{H}_{11} {H}_{μ , 1}}{{H}_{μ , 2} {H}_{11} - {H}_{μ , 1} {H}_{21}} ,$$
wherein:
H₁₁ corresponds to a voice coil admittance transfer function across the predetermined audio frequency range;
H₂₁ corresponds to a transfer function between the second compensation signal, of the compensation coil, and the current in the voice coil across the predetermined audio frequency range;
H_{μ,1} corresponds to a transfer function between the voice coil compensation signal a magnetizing inductance representing the mutual inductance created by a magnetic flux in common with the voice coil and compensation coil across the predetermined audio frequency range;
H_{μ,2} corresponds to a transfer function between the second compensation signal, of the compensation coil, and the magnetizing inductance across the predetermined audio frequency range.

5. An electrodynamic loudspeaker assembly according to claim 1, further comprising:
a first power amplifier or buffer inserted between the voice coil compensation signal and the voice coil,
a second power amplifier or buffer inserted between the output of the second compensation filter and the compensation coil.

6. An electrodynamic loudspeaker assembly according to claim 1, wherein the voice coil has a DC resistance between 1Ω and 100Ω and the compensation coil has a DC resistance between 0.5Ω and 50Ω.

7. An electrodynamic loudspeaker assembly according to claim 1, comprising a first analog-to-digital converter configured to convert the audio input signal into a digital audio input signal at a predetermined sample rate;
each of the first and second compensation filters comprising a digital filter.

8. An electrodynamic loudspeaker assembly according to claim 1, wherein the magnetic flux generator comprises at least one permanent magnet configured to produce the constant or DC magnetic flux through the magnetically permeable structure.

9. A sound reproducing system comprising an electrodynamic loudspeaker assembly according to claim 1.

10. A method of suppressing magnetic flux modulation in an air gap of an electrodynamic loudspeaker, comprising steps of:
producing a magnetic flux in the air gap of the electrodynamic loudspeaker,
coupling a first compensation filter having a first frequency response to a voice coil of the electrodynamic loudspeaker,
coupling a second compensation filter having a second frequency response to a compensation coil wound around a portion of a magnetically permeable structure of the electrodynamic loudspeaker,
applying an audio input signal from an audio signal source to each of the first and second compensation filters to supply a voice coil compensation signal to the voice coil and a second compensation signal to the compensation coil,
adjusting the first and second frequency responses to, across a predetermined audio frequency range, suppress a time-varying or AC magnetic flux in the air gap caused by voice coil current;
thereby suppressing magnetic flux modulation in the air gap.

11. A method of suppressing magnetic flux modulation in an air gap of an electrodynamic loudspeaker, according to claim 10, comprising adjusting the first and second frequency responses during a calibration procedure wherein said calibration procedure comprises steps of:
determining a voice coil admittance function H₁₁ across the predetermined audio frequency range;
determining a transfer function H₂₁ between the second compensation signal, of the compensation coil, and the current in the voice coil across the predetermined audio frequency range;
determining a transfer function H_{μ,1} between the voice coil compensation signal and a magnetizing inductance representing the mutual inductance created by a magnetic flux in common with the voice coil and compensation coil across the predetermined audio frequency range;
determining a transfer function H_{μ,2} between the second compensation signal, of the compensation coil, and the magnetizing inductance across the predetermined audio frequency range; and
adjusting the first frequency response T_{FC} of the first compensation filter and adjusting the second frequency response T_{VC} of the second compensation filter in accordance with:
$${T}_{VC} = 1 + \frac{{H}_{21} {H}_{μ , 1}}{{H}_{μ , 2} {H}_{11} - {H}_{μ , 1} {H}_{21}} , \\ {T}_{FC} = - \frac{{H}_{11} {H}_{μ , 1}}{{H}_{μ , 2} {H}_{11} - {H}_{μ , 1} {H}_{21}} .$$

12. A method of suppressing magnetic flux modulation according to claim 10, comprising adaptively adjusting each of the first and second frequency responses of the first and second compensation filters, respectively, over time in accordance with instantaneous displacement of the diaphragm assembly from its centered or unbiased position.

13. A method of suppressing magnetic flux modulation according to claim 11, comprising steps of:
determining the transfer function H_{μ,1} by inserting a field pick-up coil with known inductance into the air gap and measuring a first response signal of the field pick-up coil to the voice coil compensation signal,
determining the transfer function H_{μ,2} by inserting the field pick-up coil into the air gap and measuring a second response signal of the field pick-up coil to the second compensation signal.

14. A method of suppressing magnetic flux modulation according to claim 11, comprising steps of:
coupling a force transducer to the voice coil to measure a plurality of force values on voice coil in response to respective combinations of voice coil current and compensation coil current,
varying the voice coil and compensation coil currents independently in order to determining the transfer functions H_{μ,1} and H_{μ,2} by separating the force contributions of the voice coil current and the compensation coil current to the measured force values on the voice coil according to:
$${F}_{L} = Bl \cdot i = {bL}_{μ} {i}_{μ} i = {bL}_{μ} ( {i}^{2} + \frac{1}{K} {i}_{2} i ) .$$

15. An electrodynamic loudspeaker assembly according to claim 2, wherein the first frequency response T_{VC} of the first compensation filter and the second frequency response T_{FC} of the second compensation filter have frequency responses conforming to:
$${T}_{VC} = 1 + \frac{{H}_{21} {H}_{μ , 1}}{{H}_{μ , 2} {H}_{11} - {H}_{μ , 1} {H}_{21}} , \\ {T}_{FC} = - \frac{{H}_{11} {H}_{μ , 1}}{{H}_{μ , 2} {H}_{11} - {H}_{μ , 1} {H}_{21}} ,$$
wherein:
H₁₁ corresponds to a voice coil admittance transfer function across the predetermined audio frequency range;
H₂₁ corresponds to a transfer function between the second compensation signal, of the compensation coil, and the current in the voice coil across the predetermined audio frequency range;
H_{μ,1} corresponds to a transfer function between the voice coil compensation signal a magnetizing inductance representing the mutual inductance created by a magnetic flux in common with the voice coil and compensation coil across the predetermined audio frequency range;
H_{μ,2} corresponds to a transfer function between the second compensation signal, of the compensation coil, and the magnetizing inductance across the predetermined audio frequency range.

16. An electrodynamic loudspeaker assembly according to claim 2, further comprising:
a first power amplifier or buffer inserted between the voice coil compensation signal and the voice coil,
a second power amplifier or buffer inserted between the output of the second compensation filter and the compensation coil.

17. An electrodynamic loudspeaker assembly according to claim 3, wherein the first frequency response T_{VC} of the first compensation filter and the second frequency response T_{FC} of the second compensation filter have frequency responses conforming to:
$${T}_{VC} = 1 + \frac{{H}_{21} {H}_{μ , 1}}{{H}_{μ , 2} {H}_{11} - {H}_{μ , 1} {H}_{21}} , \\ {T}_{FC} = - \frac{{H}_{11} {H}_{μ , 1}}{{H}_{μ , 2} {H}_{11} - {H}_{μ , 1} {H}_{21}} ,$$
wherein:
H₁₁ corresponds to a voice coil admittance transfer function across the predetermined audio frequency range;
H₂₁ corresponds to a transfer function between the second compensation signal, of the compensation coil, and the current in the voice coil across the predetermined audio frequency range;
H_{μ,1} corresponds to a transfer function between the voice coil compensation signal a magnetizing inductance representing the mutual inductance created by a magnetic flux in common with the voice coil and compensation coil across the predetermined audio frequency range;
H_{μ,2} corresponds to a transfer function between the second compensation signal, of the compensation coil, and the magnetizing inductance across the predetermined audio frequency range.

18. An electrodynamic loudspeaker assembly according to claim 3, further comprising:
a first power amplifier or buffer inserted between the voice coil compensation signal and the voice coil,
a second power amplifier or buffer inserted between the output of the second compensation filter and the compensation coil.

19. An electrodynamic loudspeaker assembly according to claim 2, wherein the magnetic flux generator comprises at least one permanent magnet configured to produce the constant or DC magnetic flux through the magnetically permeable structure.

20. An electrodynamic loudspeaker assembly according to claim 3, wherein the magnetic flux generator comprises at least one permanent magnet configured to produce the constant or DC magnetic flux through the magnetically permeable structure.
